(19) United States
(12) Patent Application Publication
(10) Pub. No.: US 2007/0067796 A1
(43) Pub. Date: Mar. 22, 2007

(54) Method and apparatus for providing advertisement in digital broadcasting system

(75) Inventor: Ju-hee Seo, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/445,268

(22) Filed: Jun. 2, 2006

(30) Foreign Application Priority Data
Jul. 19, 2005 (KR) 10-2005-0065418

(51) Int. Cl. H04N 7/10; H04N 5/445; H04N 7/025; G06F 3/00

(52) U.S. Cl. 725/32; 725/34; 725/42

(57) ABSTRACT

A method and apparatus for providing advertisements in a digital broadcasting system. The method includes: multiplexing video elementary streams (ESs) for a service channel into at least two transmission streams (TSs); and storing priority information on each of the ESs, wherein the video ESs includes at least one video ES for advertisements, and their reproduction order is determined based on the priority information on each of the ESs. Therefore, an additional video stream for advertisements is added to a TS stream separately from a general video stream, thereby providing advertisements in a DMB system along with or sequentially to a general video service.

### BACKGROUND OF THE INVENTION

This application claims priority from Korean Patent Application No. 10-2005-0065418, filed on Jul. 19, 2005, in the Korean Intellectual Property Office, which is incorporated herein in its entirety by reference.

1. Field of the Invention

Apparatuses and methods consistent with the present invention relate to digital broadcasting systems, and more particularly, to providing advertisements in a digital broadcasting system.

2. Description of the Related Art

Digital broadcasting systems vary from country to country. Examples of such systems include digital multimedia broadcasting (DMB) in Korea, digital audio broadcasting (DAB) in Europe, DMB-T in China, DVB-T in Europe, etc. Exemplary embodiments of the present invention can be widely applied to the field of digital broadcasting. However, for descriptive convenience, exemplary embodiments of the present invention has been described in reference to a DMB system.

DMB refers to mobility-specific services capable of providing high quality audio and video contents. Due to unlimited mobility, DMB service delivers a wide range of contents encompassing music, text or video clips to mobile or fixed terminals including mobile phones, PDAs or portable TVs.

The DMB system provides various multimedia data services including a video service and DAB, which is popular in Europe. The DAB system, which is designed to digitalize AM and FM radio broadcasting, is a Eureka-147 DAB system that provides audio and data services.

To provide the DMB system, broadcasters manufacture video, audio, and data programs and transmit them to multiplexer broadcasters (broadcasting centers). Multiplexer broadcasters multiplex and channel-code video, audio, and data signals transmitted by channel broadcasters and transmit the multiplexed signals to a transmitting station. The transmitting station modulates the received signals into CODFM signals and transmits the modulated signals. Users receive the DMB signals using household, portable, and car terminals and enjoy high quality multimedia broadcasting.

The broadcasting center requires a profit model used to provide DMB. In a wired TV, the profit model can be advertisements provided between programs. Advertisements are indispensable to DMB.

While TV broadcasting is provided to users based on a predetermined schedule, users can select a desired program from a DMB service any time they wish. Therefore, DMB does not guarantee when or how much users are exposed to advertisements. It is also disadvantageous that additional advertisements to DMB may result in users turning off their terminals as they please.

### SUMMARY OF THE INVENTION

The present invention provides a method and apparatus for effectively providing advertisements in a digital multimedia broadcasting (DMB) system according to characteristics of DMB.

According to an aspect of the present invention, there is provided a method of providing advertisements in a digital broadcasting system, the method comprising: multiplexing video elementary streams (ESs) for a service channel into at least two transmission streams (TSs); and storing priority information on each of the ESs, wherein the video ESs include at least one video ES for advertisements, and the reproduction order of the ESs is determined based on the priority information.

Priority of a video ES for general video service may be determined to be higher than priority of a video ES for advertisements.

The priority information of the ES may be included in an object descriptor (OD) stream included in the TSs.

The video ESs may further comprise a video ES for additional service including education, weather, stock, transportation, and news.

According to another aspect of the present invention, there is provided a method of providing advertisements in a digital broadcasting system, the method comprising: demultiplexing at least two video ESs for a service channel from a received TS; extracting priority information of each of the demultiplexed video ESs from the received TS; and reproducing at least one video ES for advertisements in the video ESs prior to an ES for general video service based on the extracted priority information.

The video ES for advertisements may be first reproduced before the general video ES is reproduced.

The video ES for advertisements and the general video ES may be simultaneously reproduced on a screen.

If there is more than one video ES for advertisements, the video ESs for advertisements may be sequentially reproduced based on the priority information on each of the ESs.

The time for reproducing the video ES for advertisement may be adjusted as selected by a user.

The method may further comprise: moving to a website related to the video ES for an advertisement being reproduced according to a user's selection.

Information on the website related to the video ES for an advertisement may be included in anchor node information of a binary format scene descriptor (BIFS).

According to still another aspect of the present invention, there is provided an apparatus for providing advertisements in a digital broadcasting system, the apparatus comprising: means for multiplexing video ESs for a service channel into at least two TSs; and means for storing priority information on each of the ESs, wherein the video ESs includes at least one video ES for advertisements, and their reproduction order is determined based on the priority information on each of the ESs.

According to yet another aspect of the present invention, there is provided an apparatus for providing advertisements in a digital broadcasting system, the method comprising: means for demultiplexing at least two video ESs for a service channel from a received TS; means for extracting priority information on each of the demultiplexed video ESs from the received TS; and means for reproducing at least one video ES for advertisements in the video ESs prior to an ES for general video service based on the extracted priority information.

### BRIEF DESCRIPTION OF THE DRAWINGS

The above and other aspects of the present invention will become more apparent by describing in detail exemplary embodiments thereof with reference to the attached drawings in which:

FIG. 1 illustrates a frame structure of a digital multimedia broadcasting (DMB) system according to an exemplary embodiment of the present invention;

FIG. 2 is a conceptual diagram of an apparatus for providing advertisements in the DMB system according to an exemplary embodiment of the present invention;

FIG. 3 is a block diagram of a DMB transmitter providing advertisements in the DMB system according to an exemplary embodiment of the present invention;

FIG. 4 is a block diagram of a DMB receiver providing advertisements in the DMB system according to an exemplary embodiment of the present invention;

FIG. 5 is a detailed block diagram of a transmission stream (TS) stream processor of the DMB receiver illustrated in FIG. 4;

FIG. 6 exemplarily illustrates an object descriptor (OD) stream including priority information of video streams for advertisements according to an exemplary embodiment of the present invention;

FIG. 7 is a flowchart of a method of providing advertisements in the DMB system according to an exemplary embodiment of the present invention;

FIG. 8 is a flowchart of a method of storing an additional video stream for advertisements in diverse methods of providing advertisements according to an exemplary embodiment of the present invention;

FIG. 9 exemplarily illustrates an advertisement method using an additional video stream according to an exemplary embodiment of the present invention; and

FIG. 10 exemplarily illustrates an advertisement method using an additional video stream according to another exemplary embodiment of the present invention.

### DETAILED DESCRIPTION OF THE INVENTION

Exemplary embodiments of the present invention will now be described more fully with reference to the accompanying drawings, in which exemplary embodiments of the invention are shown. In this disclosure, detailed descriptions of conventional techniques and conventional structures that are considered related to the present invention may not be presented if this will make the concept or scope of the present invention unclear. In addition, all terms mentioned throughout this disclosure are generally defined based on the functions of what they represent in the present invention, and thus, their definitions may vary depending on a user's intent or customs. Therefore, those terms should be defined based on the content of the present invention presented herein in the present disclosure.

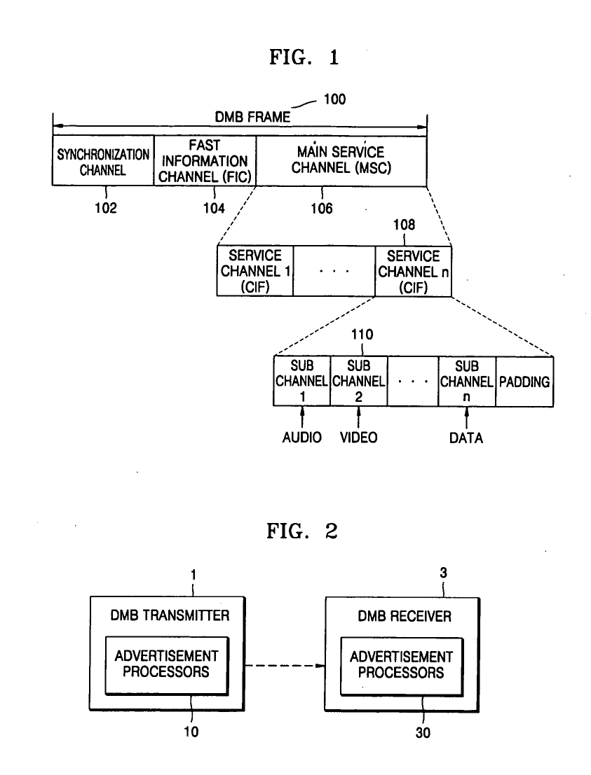

FIG. 1 illustrates a frame structure of digital multimedia broadcasting (DMB) system according to an exemplary embodiment of the present invention. Referring to FIG. 1, a DMB frame 100 includes a synchronization channel 102, a fast information channel (FIC) 104, and a main service channel (MSC) 106.

The synchronization channel 102 includes synchronization information used to demodulate the DMB frame. The FIC 104 includes diverse control information, high priority data requiring fast transmission, and service information. The FIC 104 transmits signals faster than the MSC 106, which is required to pass through an interleaver. However, the FIC 104 can transmit signals having 32 bytes only.

The MSC 106 includes data used to provide a plurality of audio services, video services, and data services. A DMB frame 100 includes a plurality of service channels 108 and each service channel 108 includes a plurality of sub channels 110. Each sub channel 110 is independently encoded and interleaved and then multiplexed as a MSC. The data used to provide a plurality of audio services, video services, and data services are packetized into MPEG-2 transmission streams (TSs) in each sub channel 110. A TS stream forming a sub channel 110 includes video streams, audio streams, and additional streams, etc.

The present invention may further include an additional video stream to provide advertisements in the DMB system.

FIG. 2 is a conceptual diagram of an apparatus for providing advertisements in the DMB system according to an exemplary embodiment of the present invention. Referring to FIG. 2, a DMB transmitter 1 and a DMB receiver 3 include advertisement processors 10 and 30, respectively, in addition to the constituents of the DMB system that code, interleave and multiplex the service channels. The advertisement processor 10 included in the DMB transmitter 1 includes additional video streams for advertisements in DMB signals to be transmitted and priority information on each of the additional video streams.

The advertisement processor 30 included in the DMB receiver 3 extracts additional video streams for advertisements from the received DMB signals in addition to an original video stream and separately stores the extracted video streams. When the DMB receiver 3 is powered on, the advertisement processor 30 determines whether the additional video streams for advertisements are further stored, and reproduces the stored video streams prior to the original video stream. Therefore, users who wish to receive DMB can watch advertisements before DMB is broadcasted in the same manner that users watch advertisements before a movie or a soap opera is broadcasted on TV.

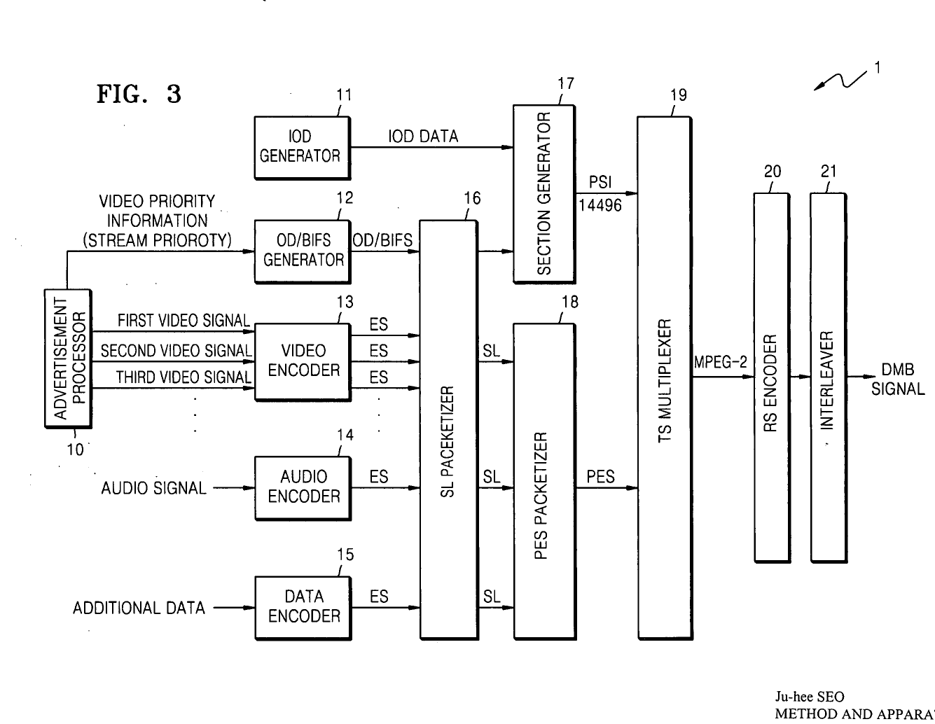

FIG. 3 is a block diagram of the DMB transmitter providing advertisements in the DMB system according to an exemplary embodiment of the present invention. Referring to FIG. 3, the DMB transmitter 1 further includes the advertisement processor 10 in addition to other constituents of the DMB transmitter 1. The advertisement processor 10 further includes an additional video signal for advertisements in addition to an original video signal. If there is more than one additional video signal, the advertisement processor 10 further includes stream priority information as an object descriptor (OD).

The operation of the DMB transmitter 1 will now be described in general.

An audio encoder 14 and a data encoder 15 code audio signals and additional data, respectively, and generate elementary streams (ESs). Also, the advertisement processor 10 delivers an additional video signal for advertisements, in addition to the original video signal, to the video encoder 13, and delivers the stream priority information of the additional video signal to an OD/BIFS (Binary Format for Scene) generator 12. OD indicates each object of a video screen. BIFS indicates a scene descriptor that describes information on when and where each object is displayed and information on relationships between the objects. The stream priority information of the additional video signal is included in the part of the OD. The OD will be described later in detail.

In addition to the stream priority information according to the present invention, description information on objects included in each scene of video and description information of each scene are generated by the OD/BIFS generator 12. An IOD generator 11 generates description information on an initial object to be displayed on a screen.

The original video signal (a first video signal) and the additional video signals (second and third video signals) for advertisements are encoded into a plurality of ESs by the video encoder 13. The ESs for video, audio, and data services and OD/BIFS information are used by a synchronization layer packetizer 16 to generate video, audio, and data SL streams, respectively, and are converted into packetized elementary streams (PESs) by a PES packetizer 18. IOD data and the OD/BIFS information are converted into 14496 PSI streams by a section generator 17. The PES streams and the PSI information are converted into TS streams based on the MPEG-2 standard by a transport stream multiplexer 19. The TS streams are converted into DMB signals by an RS encoder 20 and an interleaver 21. DMB signals are modulated into CODFM and transmitted to users' DMB terminals, i.e., the DMB receiver 3, via a transmitting station.

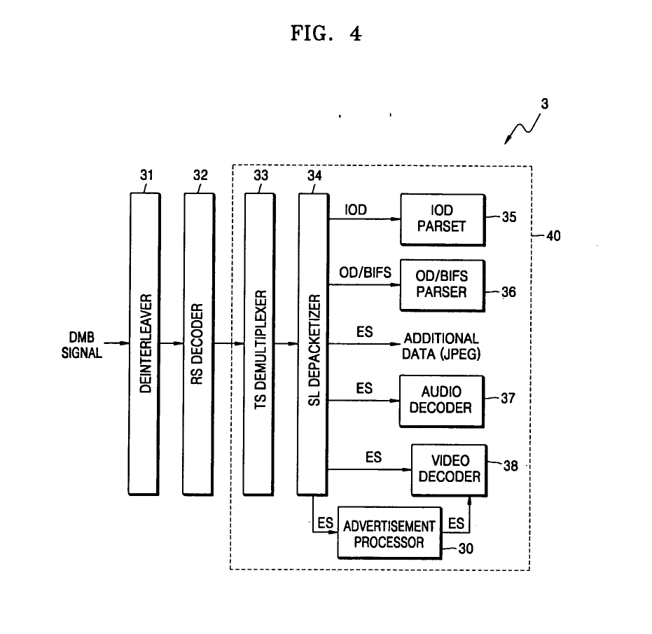

FIG. 4 is a block diagram of the DMB receiver providing advertisements in the DMB system according to an exemplary embodiment of the present invention. Referring to FIG. 4, DMB signals received by the DMB receiver 3 through a transmitting station are deinterleaved and demultiplexed and used to provide video, audio, and data services. In particular, the DMB receiver 3 further includes the advertisement processor 30 in addition to other constituents of the DMB receiver 3. The advertisement processor 30 extracts an additional video stream for advertisements, which is received in addition to an original video stream, from the received DMB signals, and separately stores the extracted video stream. When the DMB receiver 3 is powered on, the advertisement processor 30 determines whether the additional video stream for advertisements is further stored and controls a video decoder to reproduce the additional video stream for advertisements before the original video streams are reproduced.

The operation of the DMB receiver 3 is described in general.

The received DMB signals are deinterleaved and demultiplexed by a deinterleaver 31, an RS decoder 32, and a TS demultiplexer 33. The deinterleaved and demultiplexed signals are converted into ESs, IOD data, and OD/BIFS information by collecting packets included in TS streams by a SL depacketizer 34. The converted ESs, IOD data, and OD/BIFS information are decoded by a video decoder 38, an audio decoder 37, an OD/BIFS parser 36, and an IOD parser 35, and provide multimedia broadcasting services including the video, audio, and data services. The advertisement processor 30 extracts the additional video stream for advertisements which is added to the original video stream as a separate video stream, and reproduces the additional video stream for advertisements prior to the original element stream using the video decoder 38, thereby providing an advertisement service suitable for the characteristics of DMB.

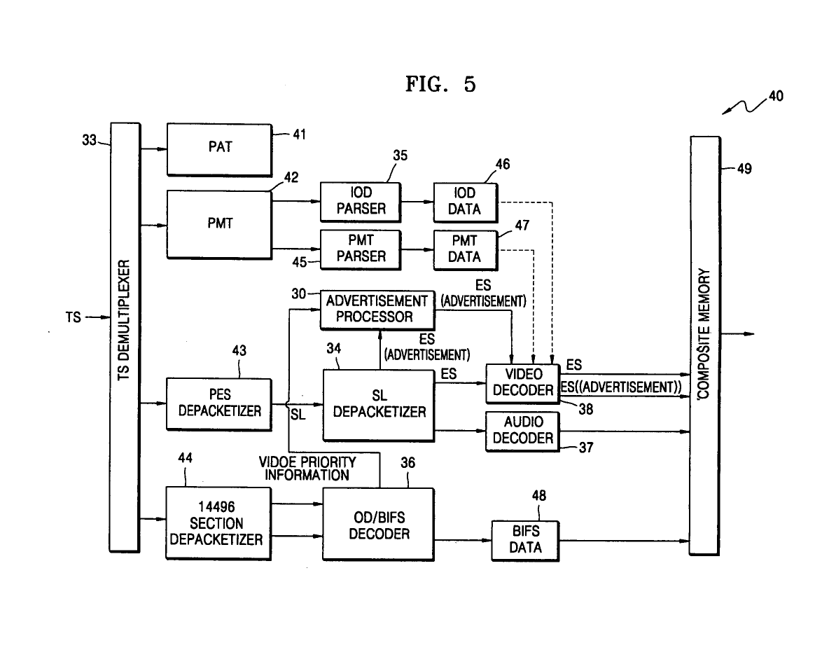

FIG. 5 is a detailed block diagram of a transport stream (TS) processor 40 of the DMB receiver 3 illustrated in FIG. 4. Referring to FIG. 5, the TS streams deliver a PAT 41, a PMT parser 42, a PES depacketizer 43, and a 14496 section depacketizer 44 through the TS demultiplexer 33. PAT and PMT related information provide an initial OD and program management table information, and are used as control information for the video decoder 38 or the audio decoder 37. The SL streams passing through the PES depacketizer 43 are converted into ESs by the SL depacketizer 34, and decoded by the video decoder 38 and the audio decoder 37. The additional video ESs for advertisements are separately stored through the advertisement processor 30. When the DMB receiver 3 is powered on, the advertisement processor 30 reads the separately stored additional video ESs for advertisements and controls the video decoder 38 to reproduce the read additional video ESs for advertisements before the original video stream. The OD/BIFS information is decoded by the OD/BIFS decoder 36 and is used for describing objects forming a screen and scenes such as objects included in each of scenes, display location and display point, and relationship between other scenes. The decoded data provide the video, audio, and data services using a composite memory 49.

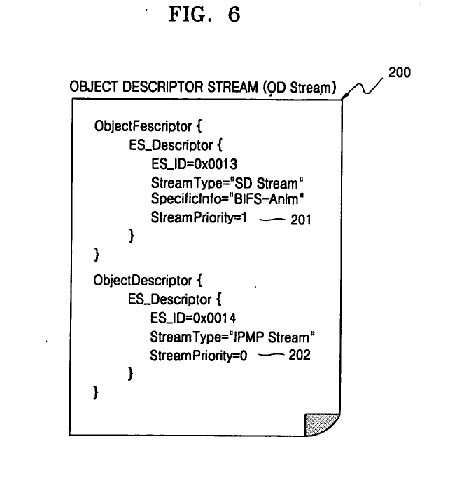

FIG. 6 exemplarily illustrates an OD stream 200 including priority information of video streams for advertisements according to an exemplary embodiment of the present invention. Referring to FIG. 6, the OD steam 200 includes a description of an ES, and may include information such as an ES identifier, a stream type, stream priorities 201 and 202, etc. In particular, stream priorities information 201 and 202 are used as standards for deciding which stream is first reproduced when there is more than one additional video streams.

A method of providing advertisements in the DMB system according to exemplary embodiments of the present invention will now be described based on the constitution of the DMB receiver 3.

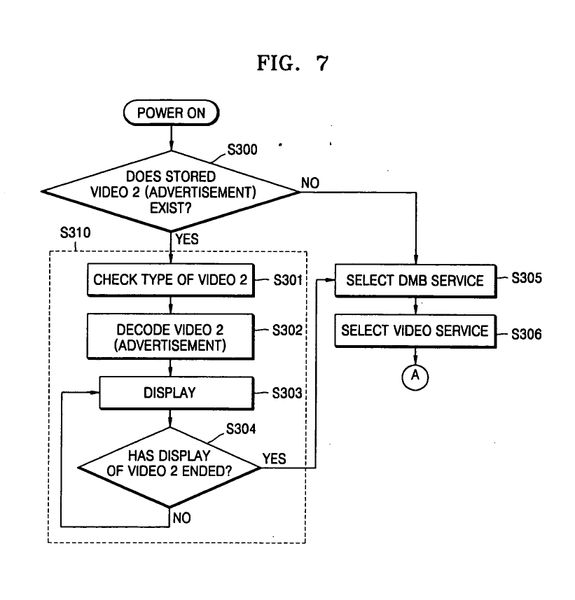

FIG. 7 is a flowchart of a method of providing advertisements in the DMB system according to an exemplary embodiment of the present invention. Referring to FIG. 7, when the DMB receiver 3 is powered on it determines whether an additional video stream for advertisements is separately stored (Operation S300). If it is determined that an additional video stream for advertisements is separately stored, the DMB receiver 3 determines the type of additional video stream (Operation S301), decodes the additional video stream (Operation S302), and displays all the video streams for advertisements (Operations S303 and S304). In this regard, the time for reproducing the video streams for advertisements can be adjusted as selected by users.

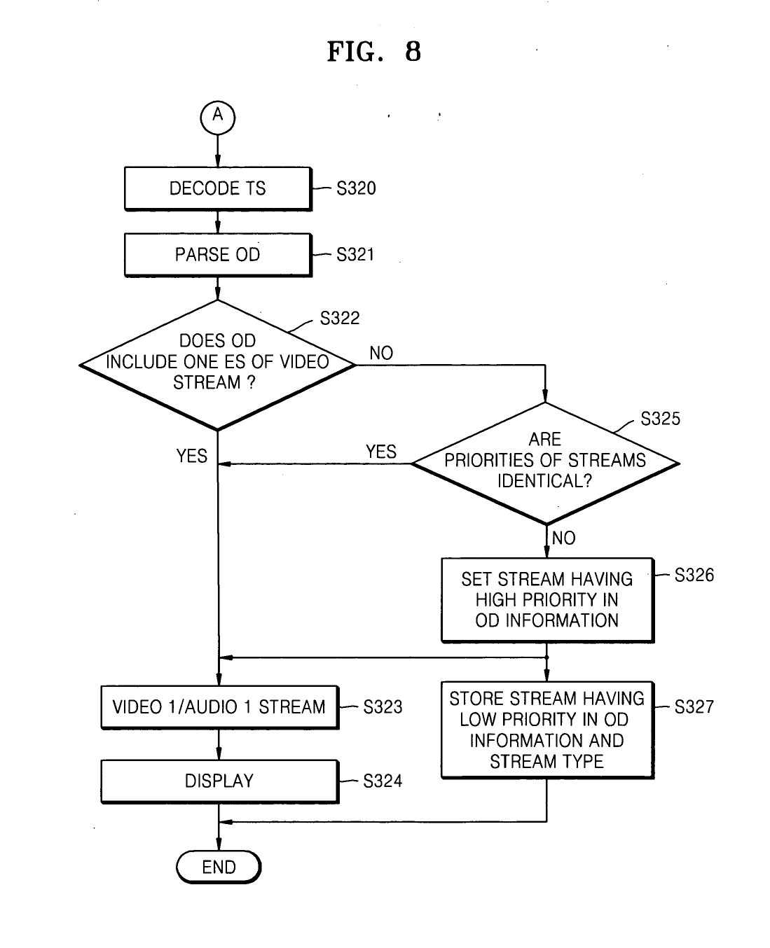

If it is determined that the additional video stream for advertisements is not separately stored, the DMB receiver 3 receives from a user selection information for selecting desired DMB services (Operation S305). If video service is selected (Operation S306), the DMB receiver 3 stores the additional video stream extracted from DMB signals (Operation A). A method of storing the additional video stream for advertisements will now be described with reference to FIG. 8.

FIG. 8 is a flowchart of a method (A) of storing the additional video stream for advertisements according to an exemplary embodiment of the present invention. Referring to FIG. 8, to store video streams for advertisements, a TS stream is decoded (Operation S320), and an OD is parsed (Operation S321). If one video stream is described in the OD (Operation S322), i.e., if an additional video stream is not included in the TS stream, general video and audio streams are decoded (Operation S323) and displayed (Operation S324). If two or more video streams are described in the OD (Operation S322), i.e., if the additional video stream is included in the TS stream (Operation S325), a video stream having high priority is reproduced as a general video stream (Operation S326), and a video stream having low priority is separately stored as a video stream for advertisements (Operation S327) based on the stream priority information. In Operation S327, the type of the video stream is also stored. The OD was described in detail with reference to FIG. 6.

A variety of advertisement methods can be realized using an additional video stream.

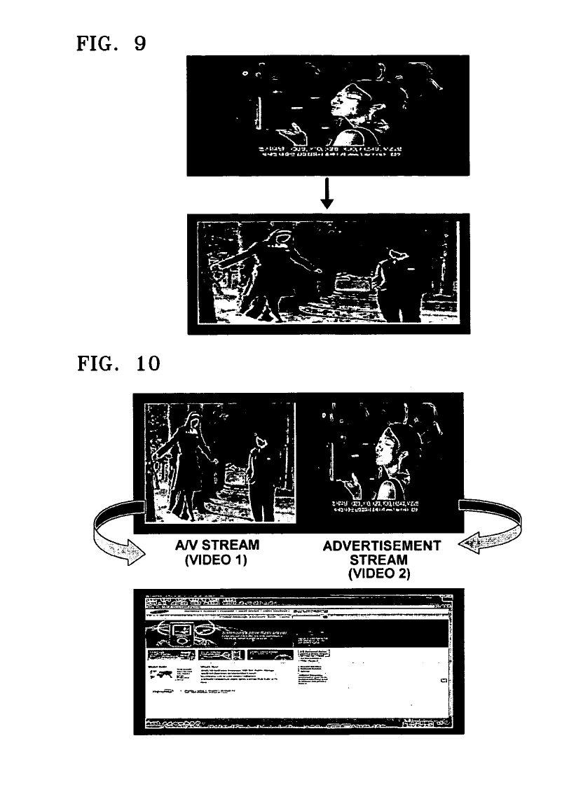

FIG. 9 exemplarily illustrates an advertisement method using an additional video stream according to an exemplary embodiment of the present invention. Referring to FIG. 9, when the DMB receiver 3 is powered on, if a user selects a desired DMB service, the DMB receiver 3 can display separately a stored additional video stream for advertisements before the selected DMB service is provided. If a plurality of additional video streams for advertisements are separately stored, video streams can be sequentially displayed in the order of highest to lowest priority based on stream priority information included in an OD. If the user clicks on an advertisement while watching the advertisement, the DMB receiver 3 can move to a website corresponding to the advertisement. In this regard, anchor node information of a BIFS can be used. Since the inclusion of information on the related website in BIFS information is a general DMB operation, its detailed description is omitted.

FIG. 10 exemplarily illustrates an advertisement method using an additional video stream according to another exemplary embodiment of the present invention. Referring to FIG. 10, when the DMB receiver 3 is powered on, if a user selects desired DMB service, the DMB receiver 3 can display a separately stored additional video stream for advertisements before the selected DMB service is provided. Unlike the method of sequentially displaying video streams shown in FIG. 9, the DMB receiver 3 can simultaneously display a general video stream and the additional video stream for advertisements on a screen. The DMB receiver 3 can display the general video stream only as selected by the user. If the user clicks on an advertisement while watching the advertisement, the DMB receiver 3 can move to a website corresponding to the advertisement.

A variety of advertisement methods using an additional video stream are described above. However, the additional video stream is not restricted to advertisements. That is, additional services including education, weather, transportation, news, etc. can be provided using the additional video stream the same as or similar to the advertisement methods.

The present invention can be implemented as a method, an apparatus, and a system. When the present invention is implemented in software, its component elements are code segments that execute necessary operations. Programs or code segments can be stored in processor readable media and can be transmitted via a computer data signal that is combined with a carrier wave in a transmission medium or in a communication network. The processor readable medium can be any medium that can store or transmit data. Examples of the processor readable medium include electronic circuits, semiconductor memory devices, ROMs, flash memories, erasable ROMs (EROMs), floppy disks, optical disks, hard disks, optical fibers, radio frequency (RF) networks, and the like.

As described above, exemplary embodiments of the present invention provides a method and apparatus for effectively providing advertisements in a DMB system according to characteristics of DMB. In detail, an additional video stream for advertisements is added to a TS stream separately from a general video stream, thereby providing advertisements in a DMB system along with or sequentially a general video service.

The exemplary embodiments of the present invention describe a DMB system only for descriptive convenience. Therefore, they can be applied to other similar digital broadcasting fields such as DAB in Europe, DMB-T in China, DVB-T in Europe, etc.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of providing advertisements in a digital broadcasting system, the method comprising:
multiplexing video elementary streams (ESs) for a service channel into at least two transmission streams (TSs); and
storing priority information on each of the video ESs,
wherein the video ESs include at least one video ES for advertisements, and a reproduction order of the video ESs is determined based on the priority information.

2. The method of claim 1, wherein priority of a video ES for general video service is determined to be higher than priority of a video ES for advertisements.

3. The method of claim 1, wherein the priority information of the video ESs is included in an object descriptor (OD) stream included in the TSs.

4. The method of claim 1, wherein the video ESs further comprise a video ES for an additional service including at least one of education, weather, stock, transportation, and news.

5. A method of providing advertisements in a digital broadcasting system, the method comprising:
demultiplexing at least two video elementary streams (ESs) for a service channel from a received transmission stream (TS);
extracting priority information of each of the demultiplexed video ESs from the received TS; and
reproducing at least one video ES for advertisements of the video ESs prior to a video ES for general video service based on the extracted priority information.

6. The method of claim 5, wherein priority of a video ES for general video service is determined to be higher than priority of a video ES for advertisements.

7. The method of claim 5, wherein the priority information on each of the video ESs is included in an object descriptor (OD) stream included in the TS.

8. The method of claim 5, wherein the video ESs further comprise a video ES for an additional service including at least one of education, weather, stock, transportation, and news.

9. The method of claim 5, wherein the at least one video ES for advertisements is first reproduced before the video ES for general video service is reproduced.

10. The method of claim 5, wherein the at least one video ES for advertisements and the video ES for general video service are simultaneously reproduced on a screen.

11. The method of claim 9, wherein, if there is more than one video ES for advertisements, the video ESs for advertisements are sequentially reproduced based on the priority information on each of the video ESs for advertisements.

12. The method of claim 5, wherein a time for reproducing a video ES for advertisement can be adjusted as selected by a user.

13. The method of claim 5, further comprising: moving to a website related to a video ES for an advertisement being reproduced according to a user's selection.

14. The method of claim 13, wherein information on the website related to the video ES for an advertisement is included in anchor node information of a binary format scene descriptor (BIFS).

15. An apparatus for providing advertisements in a digital broadcasting system, the apparatus comprising:
means for multiplexing video elementary streams (ESs) for a service channel into at least two transmission streams (TSs); and
means for storing priority information on each of the video ESs,
wherein the video ESs include at least one video ES for advertisements, and a reproduction order of the video ESs is determined based on the priority information stored on each of the ESs.

16. The apparatus of claim 15, wherein priority of a video ES for general video service is determined to be higher than priority of a video ES for advertisements.

17. The apparatus of claim 15, wherein the priority information of the video ESs is included in an object descriptor (OD) stream included in the TSs.

18. The apparatus of claim 15, wherein the video ESs further comprise a video ES for an additional service including at least one of education, weather, stock, transportation, and news.

19. An apparatus for providing advertisements in a digital broadcasting system, the apparatus comprising:
means for demultiplexing at least two video elementary streams (ESs) for a service channel from a received transmission stream (TS);
means for extracting priority information on each of the demultiplexed video ESs from the received TS; and
means for reproducing at least one video ES for advertisements of the video ESs prior to a video ES for general video service based on the extracted priority information.

20. The apparatus of claim 19, wherein priority of a video ES for general video service is determined to be higher than priority of a video ES for advertisements.

21. The apparatus of claim 19, wherein the priority information on each of the video ESs is included in an object descriptor (OD) stream included in the TS.

22. The apparatus of claim 19, wherein the video ESs further comprise a video ES for an additional service including at least one of education, weather, stock, transportation, and news.

23. The apparatus of claim 19, wherein the at least one video ES for advertisements is first reproduced before the video ES for general video service is reproduced.

24. The apparatus of claim 19, wherein the at least one video ES for advertisements and the video ES for general video service are simultaneously reproduced on a screen.

25. The apparatus of claim 23, wherein, if there is more than one video ES for advertisements, the video ESs for advertisements are sequentially reproduced based on the priority information on each of the video ESs for advertisements.

26. The apparatus of claim 19, wherein a time for reproducing a video ES for advertisement can be adjusted as selected by a user.

27. The apparatus of claim 19, further comprising: moving to a website related to a video ES for an advertisement being reproduced according to a user's selection.

28. The apparatus of claim 27, wherein information on the website related to the video ES for an advertisement is included in anchor node information of a binary format scene descriptor (BIFS).
